(19) United States
(12) Patent Application Publication
(10) Pub. No.: US 2007/0140175 A1
(43) Pub. Date: Jun. 21, 2007

(54) Atm switch for use in w-cdma

(76) Inventor: Cheol Hyun Jang, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/545,578

(22) PCT Filed: Mar. 24, 2004
(86) PCT No.: PCT/KR04/00658

§ 371 Date: Oct. 30, 2006

(51) Int. Cl. H04B 7/216; H04L 12/56

(52) U.S. Cl. 370/335; 370/395.1

(57) ABSTRACT

An ATM switch for use in a W-CDMA comprises two boards, thereby reducing the number of boards in order to increase the usability of rack space while mitigating the manufacturing costs. The ATM switch comprises a WSFA board for providing 16×16 LUDS ports of 155 Mbps and a throughput of 2.5 Gbit/s. The ATM switch h f further comprises a WLIA board for interfacing a UTOPIA interface with an OC-3c signal upon receiving an LUDA signal. The ATM switch is connected to a RAS-N block, a RAS-B block, a RAS-T block, an SCP block and a RCS block in order to perform a control function and to provide a path of call traffic.

### TECHNICAL FIELD

The present invention generally relates to an Asynchronous Transfer Mode (MM) switch, and more particularly to an ATM switch for use in a Wideband-Code Division Multiple Access (W-CDMA), wherein the ATM switch comprises two boards to thereby reduce the number of boards so as to increase the usability of rack space while mitigating manufacturing costs. The two boards comprise a W-CDMA ATM switch fabric assembly (WSFA) board and a W-CDMA link interface assembly (WLIA) board. The WSFA board provides 16×16 low voltage differential signaling (LVDS) ports of 155 Mega-bps (Mbps) and has a throughput of 2.5 Giga-bit/s (Gbit/s). The WLIA board interfaces a universal test and operations PHY interface for ATM (UTOPIA) interface with an OC-3c signal upon receiving an LVDA signal. The ATM switch is implemented on an ATM switch control processor (AIS) block of a radio network controller subsystem (RNC) in a W-CDMA system. It is then connected to a radio access subsystem-other network (RAS-N) block, a radio access subsystem-node-B (RAS-B) block, a radio access subsystem-traffic handling (RAS-T) block, an ATM switch control processor (SCP) block and an RNC control subsystem (RCS) block in order to perform a control function and to provide a path of call traffic.

### BACKGROUND ART

To provide the necessary path of call traffic, a conventional W-CDMA system employs an ATM switch that is manufactured by a third party. This obviously increases the manufacturing costs of the W-CDMA system and significantly limits the flexibility thereof.

### DISCLOSURE OF THE INVENTION

Therefore, an objective of the present invention is to provide an ATM switch for use in a W-CDMA, wherein the ATM switch comprises a WSFA board for providing 16×16 LVDS ports of 155 Mbps and a throughput of 2.5 Gbit/s. The ATM switch further comprises a WLIA board for interfacing a UTOPIA interface with an OC-3c signal upon receiving an LVDA signal. The ATM switch is connected to a RAS-N block, a RAS-B block, a RAS-T block, an SCP block and a RCS block in order to perform a control function and to provide a path of call traffic. This effectively increases the usability of rack space and reduces the manufacturing costs.

In accordance with one aspect of the present invention, there is provided an ATM switch for use in a W-CDMA which comprises a WSFA board and a WLIA board. The WSFA board comprises a user network interface (UNI) interfacing unit for performing a line interfacing function through connecting to a WLIA board by an LVDS and for interfacing an LVDS interface with a UTOPIA-2 interface; a traffic control unit (1) for performing a header translation function and a multicasting function for input/output ATM cells, (2) for interfacing a physical layer with the UTOPIA-2 interface and (3) for communicating nibble-wide data of 50 Mega-Hertz (MHz) with an upper-level layer in hierarchy; an ATM switching unit for switching incoming ATM cells; a clock generating unit for generating a synchronized clock required by functional blocks through using other synchronized clocks and a phase-locked loop (PLL); a peripheral signal control unit (1) for performing an address decoding function, (2) for performing a reset control function and (3) for collecting and generating various interrupts in a printed board assembly (PBA); and a peripheral control unit for controlling an entire board. The WLIA board interfaces a UTOPIA interface with an OC-3c signal upon receiving an LVDS signal.

In accordance with another aspect of the present invention, there is provided a WLIA board which further comprises a UNI interfacing unit. UNI interfacing unit is used for performing a line interfacing function by connecting to the WSFA board through the LVDS and for interfacing an LVDS interface with the UTOPIA-2 interface; an ATM processing unit (1) for performing a virtual path identifier (VPI)/a virtual channel identifier (VCI) address translation function, (2) for performing a quadrature amplitude modulation (QAM) processing function, (3) for performing a cell appending function and (4) for interfacing the physical layer with the UTOPIA-2 interface; a clock generating unit for generating a synchronized clock required by functional blocks through using other synchronized clock and the PLL; and a peripheral signal control unit (1) for performing an address decoding function, for performing (2) a reset control function and (3) for collecting and generating the various interrupts in the PBA.

The foregoing and other objects and features of the present invention will become more fully apparent from the following description and appended claims, taken in conjunction with the accompanying drawings.

### BRIEF DESCRIPTION OF DRAWINGS

It should be understood that these drawings depict only the preferred embodiments of the invention and are, therefore, not to be considered as limitations of its scope. The invention will be described with additional specificity and detail through the use of the accompanying drawings in which:

FIG. 1 shows a block diagram of a radio network controller subsystem (RNC) in a W-CDMA system in accordance with the present invention.

FIG. 2 shows a block diagram of a W-CDMA ATM switch fabric assembly (WSFA) in accordance with the present invention.

FIG. 3 shows a block diagram of a W-CDMA link interface assembly (WLIA) in accordance with the present invention.

### BEST MODE FOR CARRYING OUT THE INVENTION

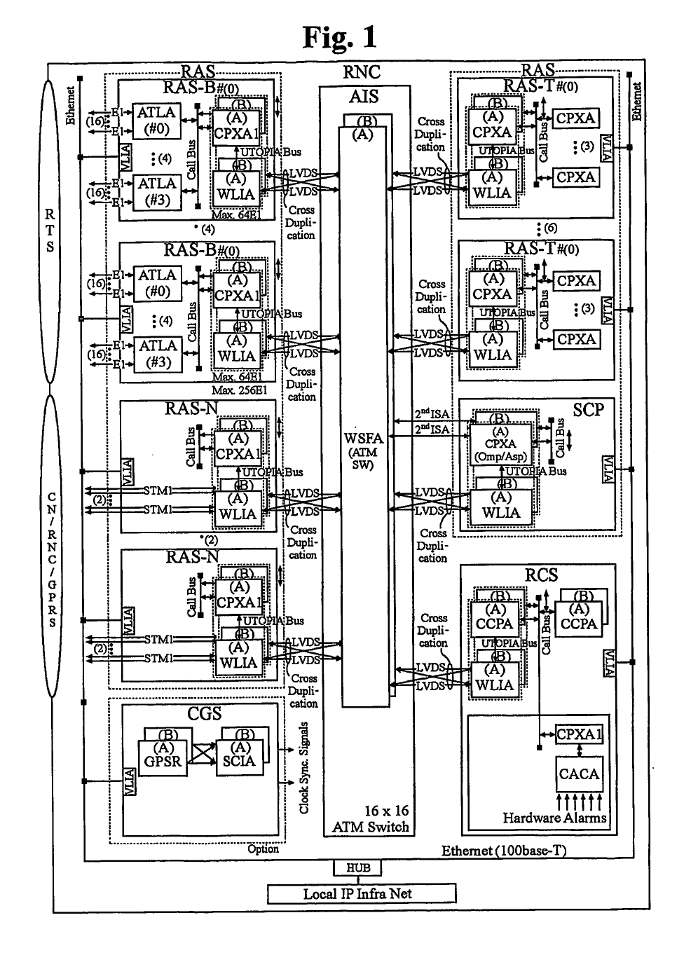

It will be readily understood that the components and steps of the present invention, as generally described and illustrated herein and in the accompanying Figures, may be arranged and designed in a wide variety of different configurations while still utilizing the inventive concept of the present invention. Thus, the detailed description of the preferred embodiments of the present invention, as described and illustrated herein and in FIGS. 1 through 3, is not intended to limit the scope of the present invention. It is merely representative of the preferred embodiments of the present invention. The preferred embodiments of the present invention will be best understood by reference to the Figures, wherein certain parts or steps described herein are designated by their corresponding numerals throughout the Figures.

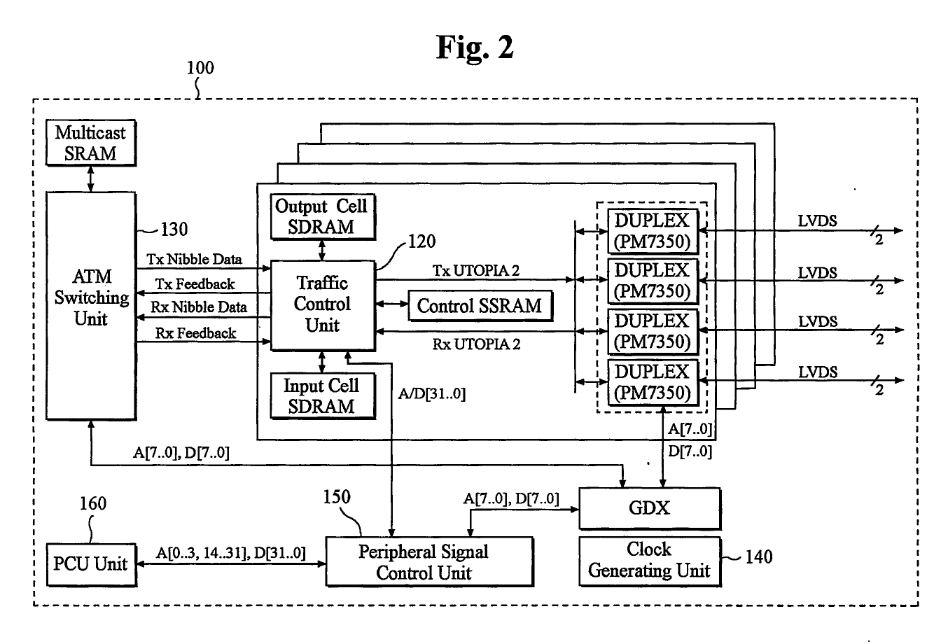

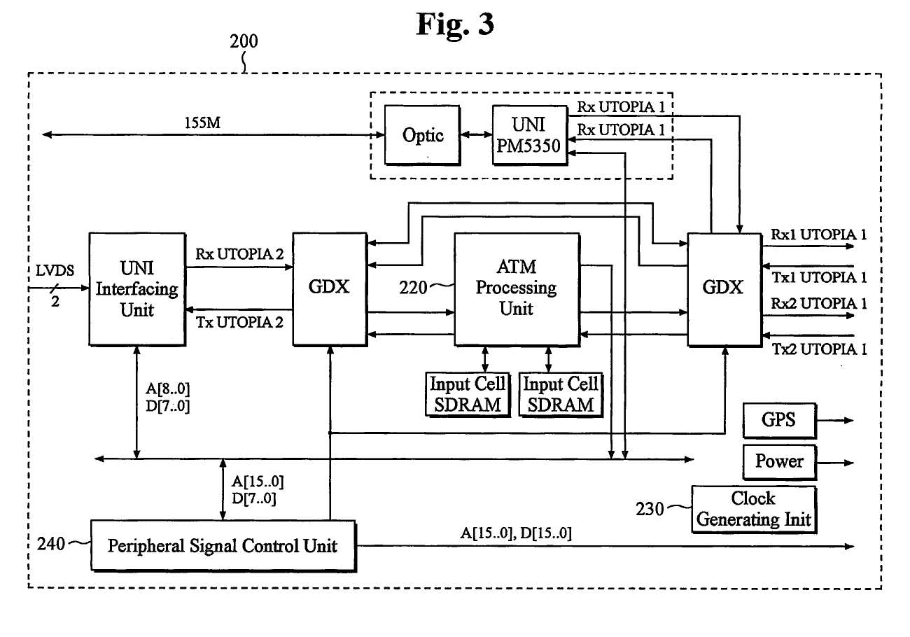

FIG. 1 shows a block diagram of a radio network controller subsystem (RNC) in a W-CDMA system in accordance with the present invention. FIG. 2 shows a block diagram of a W-CDMA ATM switch fabric assembly (WSFA) in accordance with the present invention. FIG. 3 shows a block diagram of a W-CDMA link interface assembly (WLIA) in accordance with the present invention.

As shown in FIGS. 1 through 3, an ATM switch in accordance with the present invention comprises a WSFA board 100 and a WLIA board 200. The ATM switch of the present invention is implemented on an AIS block of an RNC in a W-CDMA system. WSFA board 100 provides 16×16 LVDS ports of 155 Mbps and has a switch processing throughput of 2.5 Gbit/s. WLIA board 20 interfaces a UTOPIA interface with an OC-3c signal upon receiving an LVDA signal.

WSFA board 100 comprises a UNI interfacing unit 110, a traffic control unit 120, an ATM switching unit 130, a clock generating unit 140, a peripheral signal control unit 150 and a peripheral control unit 160. UNI interfacing unit 110 performs a line interfacing function by connecting to WLIA board 200 through a LVDS and interfaces an LVDS interface with a UTOPIA-2 interface. Traffic control unit 120 performs a header translation function and a multicasting function for input/output ATM cells, interfaces a physical layer with the UTOPIA-2 interface and communicates nibble-wide data of 50 MHz with an upper-level layer in hierarchy. ATM switching unit 130 switches incoming ATM cells. Clock generating unit 140 generates a synchronized clock required by functional blocks through using other synchronized clocks and a PLL. Peripheral signal control unit 150 performs an address decoding function and a reset control function, and further collects and generates various interrupts in a PBA. Peripheral control unit 160 controls the entire board.

Descriptions of WSFA board 100 will be described in detail with reference to FIG. 2.

UNI interfacing unit 110 performs a line interfacing function by connecting to WLIA board 200 through a LVDS and interfaces an LVDS interface with a UTOPIA-2 interface. UNI interfacing unit 110 is preferably a chip, namely, Model No. PM7350 S/UNI DUPLEX which is commercially available by PMC-SIERRA Corporation.

Traffic control unit 120 performs a header translation function and a multicasting function for input/output ATM cells, interfaces a physical layer with the UTOPIA-2 interface and communicates nibble-wide data of 50 MHz with an upper-level layer in hierarchy. Traffic control unit 120 is preferably a chip, namely, Model No. QRT PM73487 which is commercially available by PMC-SIERRA Corporation.

ATM switching unit 130 switches incoming ATM cells. ATM switching unit 130 is preferably a chip, namely, Model No. QSE PM73488 which is commercially available by PMC-SIERRA Corporation.

Clock generating unit 140 generates a synchronized clock required in functional blocks by using other synchronized clocks and a PLL. Peripheral signal control unit 150 performs an address decoding function, a reset control function and a light emitting diode (LED) control function. It further collects and generates various interrupts in a PBA. Peripheral control unit 160 comprises a MPC860, a dynamic random access memory (DRAM), a flash memory, a local static RAM (SRAM) and a line drive. Peripheral control unit 160 performs a general control function, an inter-processor communication (IPC) function and a sleep mode connection (SMC) function.

WLIA board 200 comprises a UNI interfacing unit 210, an ATM processing unit 220, a clock generating unit 230 and a peripheral signal control unit 240. UNI interfacing unit 210 performs a line interfacing function by connecting to WSFA board 100 through the LVDS and interfaces an LVDS interface with the UTOPIA-2 interface. ATM processing unit 220 performs a VPI/VCI address translation function, a QAM processing function, a cell appending function and further interfaces the physical layer with the UTOPIA-2 interface. Clock generating unit 230 generates a synchronized clock required by functional blocks through using other synchronized clock and the PLL. Peripheral signal control unit 240 performs an address decoding function and a reset control function, and further collects and generates the various interrupts in the PBA.

Description of WLIA board 200 will be described in detail with reference to FIG. 3.

UNI interfacing unit 210 performs a line interfacing function by connecting to WSFA board 100 through the LVDS and interfaces an LVDS interface with the UTOPIA-2 interface. UNI interfacing unit 210 is preferably a chip, namely, Model No. PM7350 S/UNI DUPLEX which is commercially available by PMC-SIERRA Corporation.

ATM processing unit 220 performs a VPI/VCI address translation function, a QAM processing function, a cell appending function and further interfaces the physical layer with the UTOPIA-2 interface. ATM processing unit 220 is preferably a chip, namely, Model No. ATLAS PM7324 which is commercially available by PMC-SIERRA Corporation.

Clock generating unit 230 generates a synchronized clock required in functional blocks through using other synchronized clock and the PLL. Peripheral signal control unit 240 performs an address decoding function, a reset control function, an LED control function and further collects and generates the various interrupts in the PBA.

The ATM switch in accordance with the present invention is connected to a RAS-N block, a RAS-B block, a RAS-T block, an SCP block and a RCS block in order to perform a control function and to provide a path of call traffic.

Description for the operation of 16×16 ATM switches will be described in detail.

WLIA board 200 receives an OC-3a signal from an optic cable or a UTOPIA interface signal from a CPXA so as to transmit it to UNI interfacing unit 210 through ATM processing unit 220. UNI interfacing unit 210 converts the

UTOPIA interface signal into an LVDA signal in order to transmit it to WSFA board 100.

Thereafter, WSFA board 100 re-converts the LVDA signal into the UTOPIA interface signal in order to transmit it to traffic control unit 120. Further, WSFA board 100 performs a header translation on the UTOPIA interface signal for transmission to ATM switching unit 130. During this time, ATM switching unit 130 performs a switching operation with reference to a tag of a header and transmits an ATM cell to each port in a reverse-order.

### INDUSTRIAL APPLICABILITY

In accordance with the present invention, an ATM switch for use in a W-CDMA comprises a WSFA board for providing 16×16 LVDS ports of 155 Mbps and a throughput of 2.5 Gbit/s. Such ATM switch further comprises a WLIA board for interfacing a UTOPIA interface with an OC-3c signal upon receiving an LVDA signal. The ATM switch is connected to a RAS-N block, a RAS-B block, a RAS-T block, an SCP block and a RCS block in order to perform a control function and to provide a path of call traffic. As a result, the usability of rack space is increased and the manufacturing costs are reduced.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. An Asynchronous Transfer Mode (ATM) switch for use in a Wideband-Code Division Multiple Access (W-CDMA), comprising:
a W-CDMA ATM switch fabric assembly (WSFA) board, wherein the WSFA board comprises a UNI interfacing unit for performing a line interfacing function through connecting to a W-CDMA link interface assembly (WLIA) board by a low voltage differential signaling (LVDS) and for interfacing an LVDS interface with a universal test and operations PHY interface for ATM (UTOPIA)-2 interface; a traffic control unit for performing a header translation function and a multicasting function for input/output ATM cells, for interfacing a physical layer with the UTOPIA-2 interface and for communicating nibble-wide data of 50 Mega-Hertz (MHz) with an upper-level layer in hierarchy; an ATM switching unit for switching incoming ATM cells; a clock generating unit for generating a synchronized clock required by functional blocks through using other synchronized clocks and a phase-locked loop (PLL); a peripheral signal control unit for performing an address decoding function, for performing a reset control function and for collecting and generating various interrupts in a printed board assembly (PBA); and a peripheral control unit for controlling an entire board; and
the WLIA board for interfacing a UTOPIA interface with an OC-3c signal upon receiving an LVDS signal,
wherein the ATM switch is implemented on an ATM switch control processor (AIS) block in a radio network controller subsystem (RNC) of a W-CDMA system.

2. The switch of claim 1 wherein the WLIA board further comprises:
a UNI interfacing unit for performing a line interfacing function by connecting to the WSFA board through the LVDS and for interfacing an LVDS interface with the UTOPIA-2 interface;
an ATM processing unit for performing a virtual path identifier (VPI)/a virtual channel identifier (VCI) address translation function, a quadrature amplitude modulation (QAM) processing function, a cell appending function and for interfacing the physical layer with the UTOPIA-2 interface;
a clock generating unit for generating a synchronized clock required by functional blocks through using other synchronized clock and the PLL; and
a peripheral signal control unit for performing an address decoding function and a reset control function and for collecting and generating the various interrupts in the PBA.
